(19) United States
(12) Patent Application Publication
(10) Pub. No.: US 2026/0236336 A1
(43) Pub. Date: Aug. 13, 2026

(54) METHOD AND SYSTEM FOR PREDICTING INCIDENTS IN AN APPLICATION ENVIRONMENT

(71) Applicant: JPMorgan Chase Bank, N.A., New York, NY (US)

(72) Inventors: Vivek SOHAL, Mumbai (IN); Kailesh PADVEKAR, Mumbai (IN); Akshay CHAVAN, Khopoli (IN); Sreedevi NAIR, Mumbai (IN); Gaurang PARULEKAR, Mumbai (IN)

(73) Assignee: JPMorgan Chase Bank, N.A., New York, NY (US)

(21) Appl. No.: 19/091,224

(22) Filed: Mar. 26, 2025

(30) Foreign Application Priority Data
Feb. 7, 2025 (IN) 202511010216

(51) Int. Cl. G06F 11/07; G06F 11/00

(52) U.S. Cl. CPC G06F 11/0766; G06F 11/008; G06F 11/0793

(57) ABSTRACT

A method and system for predicting incidents in an application environment are disclosed. The method includes receiving, by the at least one processor, a set of data from a plurality of data sources associated with the application environment. The method further includes unifying, by the at least one processor, the received set of data into a unified set of metrics. The method further includes analyzing, by the at least one processor using a trained model, the unified set of metrics to identify a set of anomalies indicative of a potential incident. The method further includes validating, by the at least one processor, the identified set of anomalies to confirm the potential incident. Thereafter, the method includes generating, by the at least one processor, an alert based on the confirmed potential incident.

### CROSS-REFERENCE TO RELATED APPLICATIONS

This application claims priority benefit from Indian Application No. 202511010216, filed on February 07, 2025, in the India Patent Office, which is hereby incorporated by reference in its entirety.

### FIELD OF THE DISCLOSURE

This technology generally relates to the field of prediction of anomalies, and more particularly to a method and system for predicting incidents in an application environment.

### BACKGROUND INFORMATION

The following description of the related art is intended to provide background information pertaining to the field of the present disclosure. This section may include certain aspects of the art that may be related to various features of the present disclosure. However, it should be appreciated that this section is used only to enhance the understanding of the reader with respect to the present disclosure, and not as admission of the prior art.

In today's digital world, revenue models of an enterprise are closely linked to agility, scalability and uptime of information technology (IT) systems. However, unexpected application, server and network issues may influence the overall operation performance and expense. Also, the system administrators of the IT systems handle the mentioned unexpected application, server and network issues on a frequent basis, along with dealing with the queries of the associated users, which may lead to a slower response or actions towards the application, server and network issues. As per multiple industry surveys, the IT systems may face up to 87 hours of downtime annually, which may cause a huge business loss. In some instances, the fixation of a single IT failure event may sometimes take up to 200 minutes, which may further delay other operations, causing more loss to the business. Furthermore, the system administrators are also experiencing a considerable number of recurring IT difficulties.

In existing systems, rule engine is utilized in order to resolve various incidents based on a set of rule and threshold parameters defined by the associated concerning authorities. These rules are static in nature. Also, these rules and thresholds need to be manually tuned over time. Hence, the rule engine uses a reactive approach in order to resolve various incidents (for example, the rule engine is used only when there is an occurrence of an incident due to an anomaly). Furthermore, it is to be noted that the reactive approach of the rule engine for resolution results in a high mean time to repair (MTTR) for the application. Also, the error budget of an application is unnecessarily utilized as there is no way to predict problems. Overall, there is an adverse impact on application service level agreement (SLA).

Hence, in view of these and other existing limitations, there arises an imperative need to provide an efficient solution to overcome the above-mentioned limitations and to provide a method and system for predicting incidents in an application environment.

### SUMMARY

The present disclosure, through one or more of its various aspects, embodiments, and/or specific features or sub-components, provides, inter alia, various systems, servers, devices, methods, media, programs, and platforms for predicting incidents in an application environment.

According to an aspect of the present disclosure, a method for predicting incidents in an application environment is disclosed. The method is implemented by at least one processor. The method includes receiving, by the at least one processor, a set of data from a plurality of data sources associated with the application environment. The method further includes unifying, by the at least one processor, the received set of data into a unified set of metrics. The method further includes analyzing, by the at least one processor using a trained model, the unified set of metrics to identify a set of anomalies indicative of a potential incident. The method further includes validating, by the at least one processor, the identified set of anomalies to confirm the potential incident. Thereafter, the method includes generating, by the at least one processor, an alert based on the confirmed (i.e., validated) potential incident.

In accordance with an exemplary embodiment, the method may include triggering, by the at least one processor, a remediation action to rectify the confirmed potential incident.

In accordance with an exemplary embodiment, the trained model may include at least one from among an anomaly detection model, an isolation forest algorithm-based model, and a pattern recognition model.

In accordance with an exemplary embodiment, the set of data may include at least one from among a set of application and server logs, an application programming interface (API) metric, a system metric, a health metric, and a log metric.

In accordance with an exemplary embodiment, the set of data may be received over a predefined time window.

In accordance with an exemplary embodiment, the method may further include classifying, by the at least one processor, the confirmed potential incident based on comparison with a knowledge base a comprising set of predefined potential incidents.

In accordance with an exemplary embodiment, the method may further include rendering, by the at least one processor on a display unit, at least one from among a visualization dashboard, and a predictor dashboard.

In accordance with an exemplary embodiment, the model may be trained using historical data comprising at least one from among application usage, a set of error logs, and system performance metrics.

In accordance with an exemplary embodiment, the method may further include analyzing, by the at least one processor, a dependency graph to evaluate and visualize an impact of the identified set of anomalies on a set of applications within the application environment, wherein the dependency graph corresponds to an interconnection of the set of applications.

According to another aspect of the present disclosure, a computing device configured to implement an execution of a method for predicting incidents in an application environment is disclosed. The computing device includes a processor; a memory storing instructions; and a communication interface coupled to each of the processor and the memory. The processor may be programmed to cooperate with the instructions to perform operations including: receive a set of data from a plurality of data sources associated with the application environment; unify the received set of data into a unified set of metrics; analyze, using a trained model, the unified set of metrics to identify a set of anomalies indicative of a potential incident; validate the identified set of anomalies to confirm the potential incident; and generate an alert based on the confirmed potential incident.

In accordance with an exemplary embodiment, the operations further include trigger a remediation action to rectify the confirmed potential incident.

In accordance with an exemplary embodiment, the trained model may include at least one from among an anomaly detection model, an isolation forest algorithm-based model, and a pattern recognition model.

In accordance with an exemplary embodiment, the set of data may include at least one from among a set of application and server logs, an API metric, a system metric, a health metric, and a log metric.

In accordance with an exemplary embodiment, the set of data may be received over a predefined time window.

In accordance with an exemplary embodiment, the operations further include classify, the confirmed potential incident based on comparison with a knowledge base comprising a set of predefined potential incidents.

In accordance with an exemplary embodiment, the operations further include render on a display unit, at least one from among a visualization dashboard, and a predictor dashboard.

In accordance with an exemplary embodiment, the model may be trained using historical data comprising at least one from among application usage, a set of error logs, and system performance metrics.

In accordance with an exemplary embodiment, the operations include analyze a dependency graph to evaluate and visualize an impact of the identified set of anomalies on a set of applications within the application environment, wherein the dependency graph corresponds to an interconnection of the set of applications.

According to yet another aspect of the present disclosure, a non-transitory computer-readable storage medium storing instructions for predicting incidents in an application environment is disclosed. The instructions include executable code which, when executed by a processor, may cause the processor to perform operations including receive a set of data from a plurality of data sources associated with the application environment; unify the received set of data into a unified set of metrics; analyze, using a trained model, the unified set of metrics to identify a set of anomalies indicative of a potential incident; validate the identified set of anomalies to confirm the potential incident; and generate an alert based on the confirmed potential incident.

In accordance with an exemplary embodiment, the operations further include trigger a remediation action to rectify the confirmed potential incident.

In accordance with an exemplary embodiment, the trained model may include at least one from among an anomaly detection model, an isolation forest algorithm-based model, and a pattern recognition model.

In accordance with an exemplary embodiment, the set of data may include at least one from among a set of application and server logs, an API metric, a system metric, a health metric, and a log metric.

In accordance with an exemplary embodiment, the set of data may be received over a predefined time window.

In accordance with an exemplary embodiment, the operations further include classify, the confirmed potential incident based on comparison with a knowledge base comprising a set of predefined potential incidents.

In accordance with an exemplary embodiment, the operations further include render on a display unit, at least one from among a visualization dashboard, and a predictor dashboard.

In accordance with an exemplary embodiment, the model may be trained using historical data comprising at least one from among application usage, a set of error logs, and system performance metrics.

In accordance with an exemplary embodiment, the operations include analyze a dependency graph to evaluate and visualize an impact of the identified set of anomalies on a set of applications within the application environment, wherein the dependency graph corresponds to an interconnection of the set of applications.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary computer system for predicting incidents in an application environment, in accordance with an exemplary embodiment of the present disclosure.

FIG. 2 illustrates an exemplary diagram of a network environment for predicting incidents in an application environment, in accordance with an exemplary embodiment of the present disclosure.

FIG. 3 illustrates an exemplary system for predicting incidents in an application environment, in accordance with an exemplary embodiment of the present disclosure.

FIG. 4 illustrates an exemplary method flow diagram for predicting incidents in an application environment, in accordance with an exemplary embodiment of the present disclosure.

FIG. 5 illustrates an exemplary process flow diagram for predicting incidents in an application environment, in accordance with an exemplary embodiment of the present disclosure.

FIG. 6 illustrates an exemplary architecture of a system for predicting incidents in an application environment, in accordance with an embodiment of the present disclosure.

FIG. 7 illustrates an exemplary process flow diagram for predicting incidents in an application environment, in accordance with an exemplary embodiment of the present disclosure.

### DETAILED DESCRIPTION

Exemplary embodiments will now be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to enable other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to herein as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different.

In addition, all logical units and/or controllers described and depicted in the figures may include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to enable a description of the invention. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable storage media having instructions stored thereon for one or more aspects of the present technology as described and illustrated by way of the examples herein. The instructions in some examples may include executable code that, when executed by one or more processors, causes the processors to carry out steps necessary to implement the methods of the examples of this technology that are described and illustrated herein.

In the existing method and system, a rule engine is utilized in order to resolve various incidents based on the set of rules and threshold parameters defined by the associated concerning authorities. These rules are static in nature. Also, these rules and thresholds need to be manually tuned on over time. Hence, the rule engine uses a reactive approach in order to resolve various incidents (for example, the rule engine is used only when there is an occurrence of an incident due to an anomaly). Furthermore, it is to be noted that the reactive approach of the rule engine to resolution results in a high mean time to repair (MTTR) for the application. Also, the error budget of an application is unnecessarily utilized as there is no way to predict problems. Overall, there is an adverse impact on an application service level agreement (SLA).

To overcome the above-mentioned problems, the present disclosure provides a method and system for predicting incidents in an application environment. In the present disclosure, the system first receives a set of data from a plurality of data sources associated with the application environment. Next, the system unifies the received set of data into a unified set of metrics. Next, the system analyzes, using a trained model, the unified set of metrics to identify a set of anomalies indicative of a potential incident. Next, the system validates the identified set of anomalies to confirm the potential incident. Thereafter, the system generates an alert based on the confirmed potential incident.

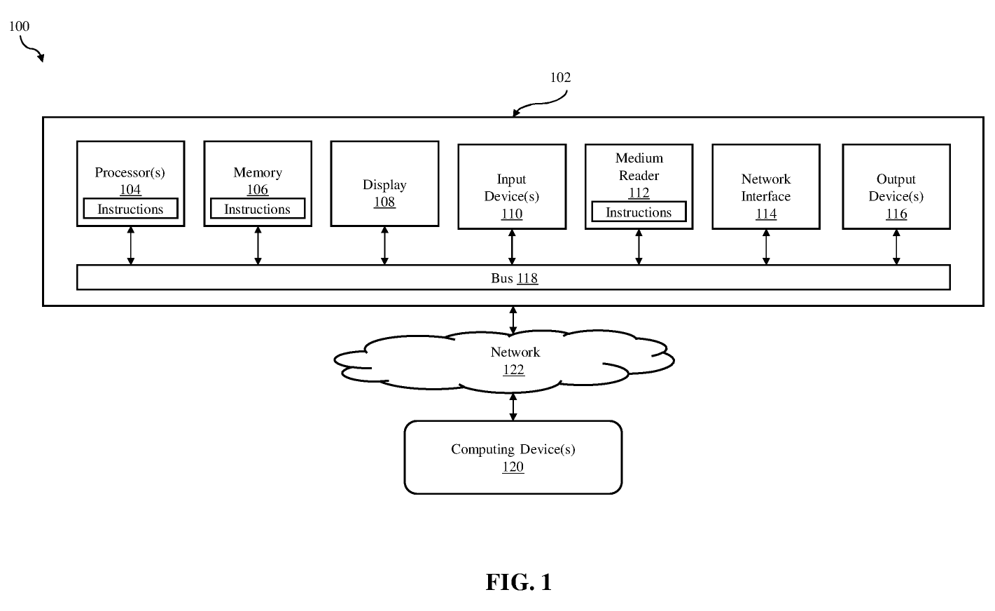

FIG. 1 is an exemplary system for use in accordance with the embodiments described herein. The system 100 is generally shown and may include a computer system 102, which is generally indicated. The term “computer system” may also be referred to herein as “computing device” and such phrases/terms can be used interchangeably in the specifications.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such a cloud-based computing environment.

In a networked deployment, the computer system 102 may operate in the capacity of a server or as a client-user computer in a server-client network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. Processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. Processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article about manufacturing and/or machine components. Memories described herein are computer-readable storage mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a Display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computing device 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof. Additionally, the term “Network interface” may also be referred to herein as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present disclosure, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art will appreciate that the above-listed devices are merely exemplary devices and that the computing device 120 may be any additional device or apparatus commonly known and understood in the art without departing from the scope of the present disclosure. For example, the computing device 120 may be the same or similar to the computer system 102. Furthermore, those skilled in the art will similarly understand that the device may be any combination of devices and apparatuses.

Of course, those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

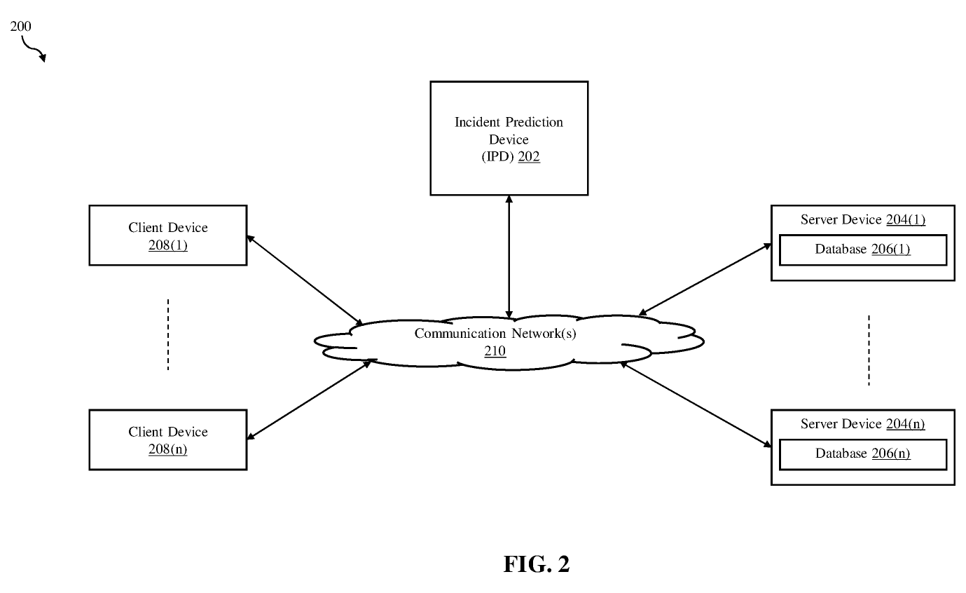

Referring to FIG. 2, a schematic of an exemplary network environment 200 for implementing a method for predicting incidents in an application environment is illustrated. In an exemplary implementation, the method is executable on any networked computer platform, such as, for example, a personal computer (PC).

The method for predicting incidents in an application environment may be executed by an incident prediction device (IPD) 202. The IPD 202 may be the same or similar to the computer system 102 as described with respect to FIG. 1. The IPD 202 may store one or more applications that may include executable instructions that, when executed by the IPD 202, cause the IPD 202 to perform desired actions, such as to transmit, receive, or otherwise process incidents, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the IPD 202 itself, may be located in the virtual server(s) running in a cloud-based computing environment rather than being tied to one or more specific physical network computing devices. Also, the application(s) may be running in one or more virtual machines (VMs) executing on the IPD 202. Additionally, in one or more embodiments of this technology, virtual machine(s) running on the IPD 202 may be managed or supervised by a hypervisor.

In the network environment 200 of FIG. 2, the IPD 202 is coupled to a plurality of server devices 204(1)-204(n) that hosts a plurality of databases 206(1)-206(n), and also to a plurality of client devices 208(1)-208(n) via communication network(s) 210. A communication interface of the IPD 202, such as the network interface 114 of the computer system 102 of FIG. 1, operatively couples and communicates between the IPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and IPD that efficiently implement the method for predicting incidents in an application environment.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, tele traffic in any suitable form (e.g., voice, modem, and the like), public switched telephone networks (PSTNs), ethernet-based packet data networks (PDNs), combinations thereof, and the like.

The IPD 202 may be a standalone device or integrated with one or more other devices or apparatuses, such as one or more of the server devices 204(1)-204(n), for example. In one particular example, the IPD 202 may include or be hosted by one of the server devices 204(1)-204(n), and other arrangements are also possible. Moreover, one or more of the devices of the IPD 202 may be in a same or a different communication network including one or more public, private, or cloud-based networks.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the IPD 202 via the communication network(s) 210 according to the hypertext transfer protocol (HTTP)-based and/or JavaScript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store information associated with the various incidents.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the IPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at one client device 208 is a wireless mobile communication device, e.g., a smartphone.

The client devices 208(1)-208(n) may run interface applications, such as standard web browsers or standalone client applications, which may provide an interface to communicate with the IPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the IPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IPD 202, the server devices 204(1)-204(n), or the client devices 208(1)-208(n), for example, may be configured to operate as virtual instances on the same physical machine. In other words, one or more of the IPD 202, the server devices 204(1)-204(n), or the client devices 208(1)-208(n) may operate on the same physical device rather than as separate devices communicating through communication network(s) 210. Additionally, there may be more or fewer IPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only tele traffic in any suitable form (e.g., voice and modem), wireless traffic networks, cellular traffic networks, packet data networks (PDNs), the Internet, intranets, and combinations thereof.

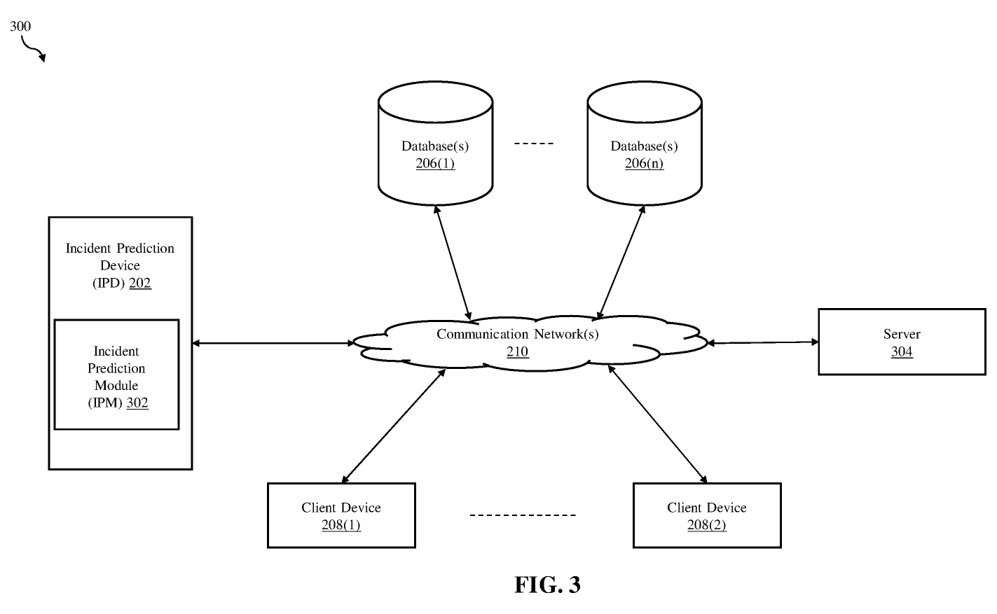

FIG. 3 illustrates an exemplary system for implementing a method for predicting incidents in an application environment, in accordance with an exemplary embodiment. As illustrated in FIG. 3, the system 300 may include an incident prediction device (IPD) 202 within which an incident prediction (IP) module (IPM) 302 is embedded, a server 304, a database(s) 206(1) … 206(n), a plurality of client devices 208(1) … 208(2), and a communication network(s) 210.

According to exemplary embodiments, the system 300 may comprise the incident prediction device (IPD) 202 including the IPM 302 may be connected to the server 304 and the database(s) 206(1) … 206(n) via the communication network(s) 210, but the disclosure is not limited thereto. The IPD 202 may also be connected to the plurality of client devices 208(1) … 208(2) via the communication network(s) 210, but the disclosure is not limited thereto. The database(s) 206(1) … 206(n) may include rule database.

In an embodiment, the IPD 202 is described and shown in FIG. 3 includes the IPM 302, although it may include other rules, policies, modules, databases, or applications, for example. As will be described below, the IPM 302 is configured to carry out a method for predicting incidents in an application environment.

An exemplary system 300 for implementing a mechanism for predicting incidents in an application environment by utilizing the network environment of FIG. 2 is shown as being executed in FIG. 3. Specifically, a first client device 208(1) and a second client device 208(2) are illustrated as being in communication with the IPD 202. In this regard, the first client device 208(1) and the second client device 208(2) may be “clients” of the IPD 202 and are described herein as such. Nevertheless, it is to be known and understood that the first client device 208(1) and/or the second client device 208(2) need not necessarily be “clients” of the IPD 202, or any entity described in association therewith herein. Any additional or alternative relationship may exist between either or both of the first client device 208(1) and the second client device 208(2) and the IPD 202, or no relationship may exist.

Further, the IPD 202 is illustrated as being able to access one or more databases 206(1) …. 206(n). The IPM 302 may be configured to access these repositories/databases for implementing a method for predicting incidents in an application environment by utilizing the network environment. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the IPD 202 via broadband or cellular communication. These embodiments are merely exemplary and are not limiting or exhaustive.

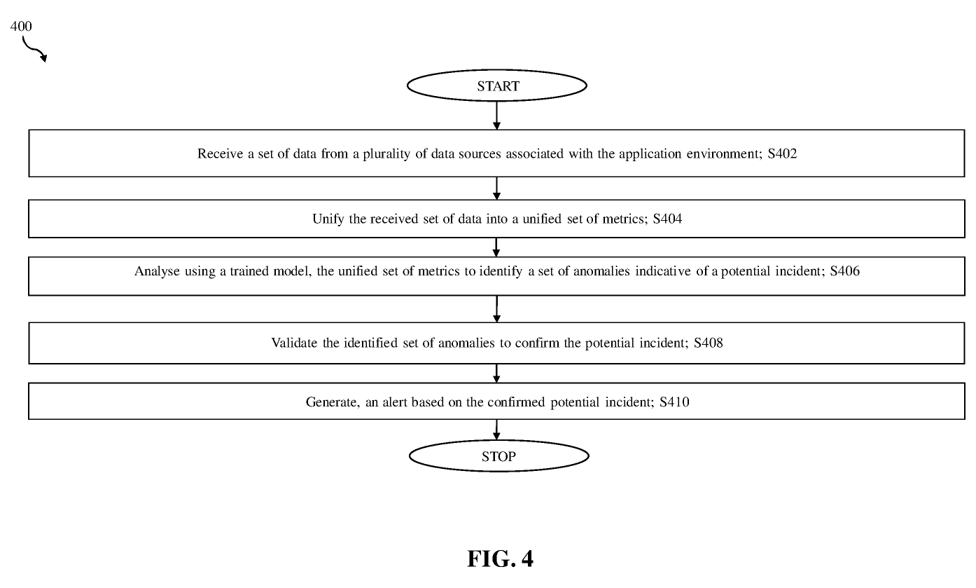

Referring to FIG. 4, an exemplary method 400 begins following a need for predicting incidents in an application environment. The method 400 is implemented by at least one processor 104.

At step S402, the method 400 includes receiving, by the at least one processor 104, a set of data from a plurality of data sources associated with the application environment. The plurality of data sources may include, for example, log files from the application server, system performance metrics, an API metrics, health check data, and other diagnostic logs.

In an exemplary embodiment, system performance metrics may be such as but not limited to system infrastructure metrics. The system infrastructure metrics may measure the performance of various information technology (IT) infrastructure components, such as the operating system, disk activity, servers or virtual machines etc.

For example, an application environment includes an e-commerce platform. In this case, the data sources might include logs from the web server that capture hypertext transfer protocol (HTTP) request and response times, error logs indicating any issues with specific requests, API metrics showing the frequency and response times of API calls, and system metrics such as a central processing unit (CPU) and memory usage on the backend servers. Additionally, health metrics from load balancers or other network components may provide data on latency and response time, which may help in identifying network-related bottlenecks.

Each of the plurality of data sources contribute different types of data, that, when combined, form a unified dataset representing the application’s health and performance. For example, the log files may contain warnings about high latency, while API metrics might indicate an increase in failed API calls.

In an exemplary implementation, the method includes receiving the set of data over a predefined time window, such as the last 24 hours or the last seven days, depending on the application's needs. It will be appreciated by the person skilled in the art that the above approach allows the system to observe patterns and changes over time, helping to detect deviations that may signal a potential incident before it escalates.

At step S404, the method includes unifying, by the at least one processor, the received set of data into a unified set of metrics. The unification process may include transforming a disparate set of data from the plurality of data sources into a standardized format that allows for cohesive analysis. Each data source may report its metrics in a different structure, unit, or format, and so the unification step standardizes these inputs to create a coherent dataset that accurately represents the application environment’s overall state.

For example, in an application environment, data is received from multiple sources, such as API logs, server performance metrics, and health monitoring tools. The API logs might report request counts, error rates, and response times, while server performance metrics might include CPU usage, memory utilization, and disk input/output (I/O). Health monitoring tools may provide latency data, uptime status, and error codes. Each source may report these metrics on different time intervals and in varying units, making direct comparisons challenging.

During unification, the at least one processor 104 normalizes these metrics so they align within a consistent framework. For example, response times from the API logs and latency data from health monitoring tools might be converted into a common unit (e.g., milliseconds) and standardized over comparable time intervals, such as hourly or daily summaries. Similarly, CPU usage from different servers may be averaged to create an aggregate metric that represents overall CPU load on the system.

The unification process may also involve calculating derived metrics that provide additional insights. For example, by combining API error rates with latency data, the at least one processor 104 may generate a "response quality" metric, which reflects how efficiently the application is serving requests. Another example may be synthesizing memory usage and disk I/O to create a "resource utilization" metric that indicates the load on the server infrastructure.

At step S406, the method includes analyzing, by the at least one processor 104 using a trained model, the unified set of metrics to identify a set of anomalies indicative of a potential incident. The at least one processor 104 applies the trained model (such as a machine learning model) that has been trained to recognize patterns in the unified metrics and detect deviations that suggest abnormal or unexpected behavior in the application environment. These deviations (such as the set of anomalies) may signal potential incidents that could disrupt application functionality if not addressed promptly.

For example, the trained model may include algorithms for anomaly detection, such as an isolation forest model or a pattern recognition model. In an exemplary embodiment, the pattern recognition models may be such as but not limited to a classification model for incident classification. These algorithms are particularly effective for identifying unusual data points in large datasets. The trained model may learn from historical data that may contain normal operational metrics and previously observed incidents, thereby allowing it to detect subtle but critical changes in the unified set of metrics that might not be immediately noticeable. The trained model may continuously compare the incoming unified metrics against established baselines, identifying any patterns or data points that deviate significantly from normal trends.

For example, the unified set of metrics may include CPU usage, memory utilization, API response times, and error rates. If the application is functioning normally, these metrics typically fall within predictable ranges. However, the trained model might detect a sudden spike in CPU usage combined with a rise in API response times and error rates. Although each metric alone might not be concerning, this combination of deviations may indicate a potential memory leak or an unexpected increase in workload that may further lead to an application slowdown or outage. The trained model flags this combination of anomalies as indicative of a potential incident, allowing further validation and action.

In another example, the application may handle a steady rate of user requests with consistent response times. The trained model may detect a pattern where the number of requests suddenly increases, and response times start to degrade, even if the system has not yet reached its threshold for maximum load. This degradation may indicate a performance bottleneck or impending overload. By identifying this anomaly early, the trained model may provide advance warning before the issue escalates into a full-blown incident.

It will be appreciated by the person skilled in the art that by analyzing the unified set of metrics using a trained model, the at least one processor 104 may identify patterns of anomalies that serve as early indicators of potential incidents. This analysis enables proactive incident management, where the system may respond to issues before they impact users, thereby enhancing the reliability and resilience of the application environment.

At step S408, the method 400 includes validating, by the at least one processor 104, the identified set of anomalies to confirm the potential incident.

The validation may involve comparing the anomalies against historical patterns or established thresholds to assess their severity and potential impact. For example, the processor might cross-check the identified anomalies against past data to see if similar metric deviations have led to incidents previously. If the same pattern of increased CPU usage and latency occurred in the past which led to an outage, the at least one processor 104 may validate that the current anomaly pattern is indeed likely to signify an incident.

Additionally, the validation may incorporate context-specific rules or additional data checks to eliminate false positives. For instance, a spike in error rates alone may not always indicate an issue if it coincides with a planned maintenance event. The processor may refer to a maintenance schedule to verify whether the anomaly is expected or abnormal. If the spike aligns with maintenance, it is marked as benign; otherwise, it is flagged as a validated (i.e., confirmed) potential incident which requires attention.

In an exemplary embodiment, considering an e-commerce platform as an example. If the platform experiences a high volume of requests during a holiday sale, certain metrics like API response times and server load might spike temporarily. The validation step may help assess whether these spikes match typical patterns seen during peak usage times, such as holiday events. If the anomalies align with expected behavior during such events, the processor may decide they do not constitute a potential incident. However, if the anomalies exceed expected levels for a holiday peak, this may suggest an underlying issue, and the anomalies are validated as indicators of a potential incident.

In an exemplary embodiment, the validation process may involve cross-referencing dependencies between services. For example, if an anomaly is detected in a dependent microservice, the processor may evaluate if anomalies in the main application are directly caused by issues in this dependent service. If so, the anomaly in the main application is validated as part of an interconnected incident, leading to a more targeted response.

In an exemplary embodiment, the validation of potential incidents is derived by historical data sets and validated by human feedback till the system reaches a level of maturity. In an exemplary implementation, various classifications models are used to classify incidents and their associated actions. A feedback loop from classification models enhances their capabilities over a period of time.

At step S410, the method 400 includes generating, by the at least one processor 104, an alert based on the confirmed potential incident. The alert may provide essential details about the incident, thereby enabling quick assessment and response to prevent or mitigate any impact on the application environment.

The alert generated by the processor 104 may include information such as the nature of the incident, affected components, a severity level, and any relevant metrics that may have led to the incident validation. For example, if the validated incident is due to a spike in API response times and memory usage, the alert might specify these metrics, the threshold levels that were exceeded, and a summary of the recent anomaly patterns. By providing specific details, the alert may help the recipient(s) in understanding the underlying issue and deciding on the necessary corrective actions.

For example, in an e-commerce application where an alert is generated due to a validated (i.e., confirmed) potential incident involving high CPU usage and an increase in failed API requests, the alert may include a message like: “ALERT: High CPU utilization detected on Server 3, with a 20% increase in API failures over the past 10 minutes. Potential impact on order processing workflows.” This level of detail gives administrators a clear information about the location and nature of the problem, allowing them to prioritize and address it more effectively.

In an exemplary implementation, the alert may be configured with a severity level based on the potential impact of the incident. For example, minor anomalies may generate “warning” alerts, while severe incidents, such as those affecting core application services, may generate “critical” alerts. This severity classification may help recipients with prioritizing their responses, and focusing on critical issues that may demand immediate attention.

Additionally, the processor may deliver the alert through various channels based on the organization's preferences and response protocols. Common channels include email notifications, short message service (SMS) messages, dashboard updates, and even direct integration with incident management platforms such as PagerDuty or ServiceNow^{TM}. For instance, an alert about a critical incident affecting a production server may be routed to an on-call engineer via SMS and logged in to an incident management system for tracking and resolution.

The method further includes triggering, by the at least one processor 104, a remediation action to rectify the confirmed potential incident. Once an incident has been confirmed through the validation process, the processor 104 may initiate an appropriate response to address and resolve the issue automatically, without requiring immediate human intervention.

The remediation action may vary depending on the type and severity of the validated incident. For example, if the validated incident is due to high memory usage, the processor may initiate a memory cleanup or trigger an automated script to restart specific application services to free up resources. In cases where a database connection issue is detected, the processor 104 may attempt to re-establish the connection or switch to a backup database.

For example, an anomaly in an e-commerce application has been validated as a potential incident involving a high failure rate of API requests. To remediate this, the processor 104 may initiate actions such as throttling incoming requests to reduce server load or redirect traffic to an alternative server, if the system is set up with load balancing capabilities. By doing so, the system may maintain service availability and minimize user impact, even while the incident is being addressed.

The processor 104 may select the appropriate remediation action based on a predefined knowledge base or set of response protocols, which specify actions for various incident types. For example, if the validated incident is a performance issue detected by high CPU usage and slow response times, the knowledge base may indicate that the recommended action is to scale up the server capacity or allocate additional resources temporarily. The processor 104 may then execute this action in real time, restoring optimal performance.

In complex scenarios, the remediation actions can be multi-step processes involving a sequence of tasks. For example, if a security anomaly is detected, such as unauthorized access patterns, the processor may first block suspicious IP addresses, then reset affected user credentials, and finally log the event in the system for audit purposes.

If, at any point, the remediation process encounters unexpected complications or if predefined thresholds are exceeded, the system may escalate the incident to an administrator, prompting manual intervention to ensure thorough resolution.

The method may further include classifying, by the at least one processor 104, the confirmed potential incident based on comparison with a knowledge base comprising a set of predefined potential incidents.

To perform the classification, the at least one processor 104 may compare the details of the validated incidents such as the type of anomaly detected, affected metrics, and severity level against entries in a knowledge base. The knowledge base is a repository of predefined incident types, each associated with specific attributes, common causes, and recommended responses. The knowledge base may have been developed using historical incidents, best practices, and expert knowledge, providing the system with insights from past experiences that aid in identifying and responding to new incidents.

For example, if the validated incident involves high CPU usage and a noticeable increase in response latency, the processor may classify this incident as a “performance degradation” issue by matching it with similar patterns stored in the knowledge base. This classification not only identifies the nature of the issue but also provides context on possible causes, such as resource exhaustion or unexpected traffic spikes. Based on this classification, the system can prioritize relevant remediation actions suited for performance-related issues or escalate the incident to the appropriate team.

In another example, an anomaly is detected in the form of repeated login failures originating from specific IP addresses. When this anomaly is validated, the processor may classify it as a “security breach – unauthorized access attempts,” as this pattern aligns with entries in the knowledge base related to suspicious activity. By classifying the incident as a security issue, the system may then trigger security-specific remediation actions, such as blocking the suspicious IP address, resetting affected user credentials, and notifying the security team to investigate further.

The method 400 may further include rendering, by the at least one processor 104 on a display unit, at least one from among a visualization dashboard and a predictor dashboard. This step enables the system to present relevant, real-time information on application health, performance metrics, and potential incidents through an intuitive, user-friendly interface. The dashboards may provide critical insights for system administrators and other stakeholders, enabling them to monitor the application environment, assess trends, and take action if necessary.

In an exemplary embodiment, the visualization dashboard may display overall health check of the applications including infrastructure and application level. The visualization dashboard may consolidate and display key metrics, offering a comprehensive view of the application’s current operational status. It may show aggregated data such as CPU usage, memory utilization, API response times, error rates, and other performance indicators. For example, the visualization dashboard may display a live graph of CPU usage over time, allowing administrators to spot patterns like unexpected spikes or consistent high utilization. By presenting these metrics visually, the dashboard allows for quick identification of performance trends and potential issues before they escalate.

In an exemplary embodiment, the predictor dashboard may include at least one from among a list of anomalies predicted and classification of the same. In an example, the predicator dashboard may also allow users to add in details if classification needs to be changed, thereby enabling faster feedback loop.

The predictor dashboard, on the other hand, may focus on potential incidents that have been identified through the system’s anomaly detection and prediction processes. It may highlight active or recently validated (i.e., confirmed) potential incident, along with the metrics or anomalies that triggered the potential incident validation. For instance, if the system has detected a pattern indicating a possible database bottleneck, the predictor dashboard may display this as an alert, showing relevant metrics such as increased query response times and error counts. Additionally, the predictor dashboard may indicate the severity of each potential incident, helping administrators prioritize their responses based on impact.

Both dashboards may include interactive elements that allow users to drill down into specific metrics, adjust time frames, or view detailed logs associated with an incident. For example, a system administrator noticing high memory usage on the visualization dashboard may click on the metric to view underlying logs, helping them understand potential causes. Furthermore, the dashboards may offer customizable views, so different stakeholders may tailor the information according to their needs, such as focusing only on critical alerts or specific application components.

It will be appreciated by the person skilled in the art that by rendering these dashboards, the method may provide administrators with the tool to monitor and manage the application environment more effectively, ensuring that potential issues are addressed proactively.

The method 400 may further include analyzing, by the at least one processor 104, a dependency graph to evaluate and visualize the impact of the identified set of anomalies on a set of applications within the application environment, wherein the dependency graph may correspond to an interconnection of the set of applications.

The dependency graph represents the relationships and dependencies between various applications, services, or components within the environment. For example, in a microservices-based architecture, the dependency graph may depict each microservice as a node, with direct connections indicating dependencies between services. This structure allows the processor to understand how an anomaly in one component, such as a sudden increase in latency in a database service, may impact other services that rely on it, such as an API service that retrieves data from the database.

Upon identifying an anomaly, the processor 104 examines the dependency graph to trace potential pathways through which the issue may propagate across interconnected services. For example, if the anomaly involves high latency in a key service, the processor 104 assesses all dependent services and evaluates whether they are likely to experience performance degradation or failures as a result. This analysis may reveal critical information, such as which services are at risk of cascading failures, allowing administrators to prioritize remediation efforts for components with the highest potential impact on the overall system.

In addition to assessing direct impacts, the dependency graph analysis may help visualize the ripple effects of an incident. For example, if a front-end service relies on a series of backend services, the processor may use the graph to identify indirect dependencies, such as intermediate services that may also be affected if the front-end service experiences issues. This visualization provides a clear picture of the scope of the incident, helping administrators understand the full extent of the potential impact and allocate resources accordingly.

In an exemplary embodiment, the dependency graph analysis may also support the visualization dashboard, where affected components and their dependencies may be highlighted. For example, components directly impacted by the anomaly could appear in red, while indirectly affected components may be shown in yellow, giving administrators a color-coded map of incident propagation across the application ecosystem.

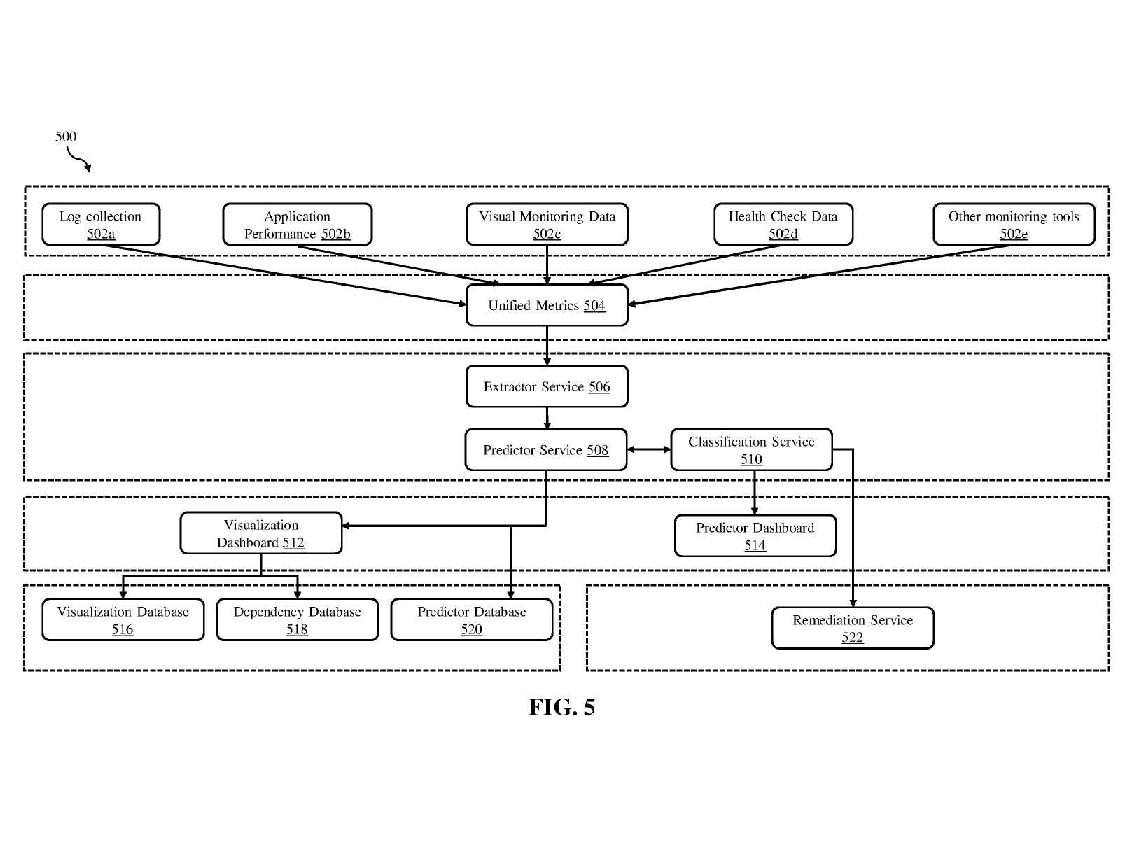

FIG. 5 illustrates an exemplary process flow diagram 500 for predicting incidents in an application environment, in accordance with an exemplary embodiment of the present disclosure.

As shown in FIG. 5, the process flow diagram 500 comprises a plurality of data sources (502a, 502b, 502c, 502d, 502e) within an application environment that feed monitoring data into unified metrics 504. The plurality of data sources may include log collection 502a, application (or App) performance 502b, visual monitoring data 502c, health check data 502d, and other monitoring tools 502e. The log collection 502a may capture logs from diverse sources, including application and system logs, which record events, warnings, and errors. The application performance 502b may gather key performance metrics, such as response times and error rates, offering a view of the application’s overall health. The visual monitoring data 502c may collect metrics from user interface or user experience monitoring tools, allowing real-time tracking of user interactions. The health check data 502d may collect data from load balancers or other network components to verify whether different application components are functioning as expected, such as checking server uptime and network status. The other monitoring tools 502e may represent additional sources like network monitoring and security analytics tools. The monitoring data from these tools is combined to predict the occurrence of an issue in advance.

The plurality of data sources may feed into the unified metrics 504, where the collected monitoring data is standardized and combined to create a cohesive set of metrics that represents the overall state of the application environment.

An extractor service 506, may process the set of metrics from the unified metrics 504 by aggregating, normalizing, and preparing them for analysis. The processed set of metrics may then be passed onto the predictor service 508 for prediction of issues.

The predictor service 508 may analyze the set of metrics processed by the extractor service 506. The predictor service 508 may identify issues based on unusual patterns or metric deviations that indicate potential or possible incidents by using a trained model such as but not limited to an anomaly detection model and a pattern recognition model. Once an anomaly or a deviation is detected, a classification service 510 may validate the anomaly or the deviation and categorize the potential incident based on predefined incident types, i.e., by using a knowledge base of incident patterns. The classification service 510 facilitates providing context on the potential incident’s severity and suggested response to the predictor service 508. The identified anomaly or deviation is updated in the predictor database 520. A predictor dashboard 514 may be used as a user interface (UI) to show the anomalies detected by the predictor service 508 and categorized by the classification service 510. The predictor dashboard 514 may be dedicated for displaying detected and validated incidents, their classifications, and potential impacts. This dashboard enables administrators to see affected components, review details of anomaly patterns, and decide on any necessary manual interventions.

A visualization dashboard 512 may collate all the monitoring data from the plurality of data sources to determine the health of application environment. The anomalies detected from the predictor service 508 may be further drilled down on the visualization dashboard 512. This way, the visualization dashboard 512 may provide a high-level view of key metrics and overall application health. It consolidates performance metrics, system usage, and health indicators, allowing administrators to monitor the application’s status at a glance.

A visualization database 516 may store the historical and current metrics displayed on the visualization dashboard 512, allowing for performing trend analysis over time.

A dependency database 518 may contain a mapping of interdependencies among different components within the application environment. This supports the analysis of how an issue in one component may affect others.

The predictor database 520 may store metrics data on previously detected incidents, classifications, and remediation actions, which may be used to improve the accuracy of the predictor service 508 over time by training the model on past incidents and outcomes.

A remediation service 522 may be responsible for automatically initiating actions to resolve validated incidents. Based on the classification provided by the classification service 510, the remediation service 522 may trigger predefined remediation actions, such as restarting a service, scaling resources, or blocking a suspicious IP. This automated response may prevent incidents from escalating and helps maintain smooth application performance.

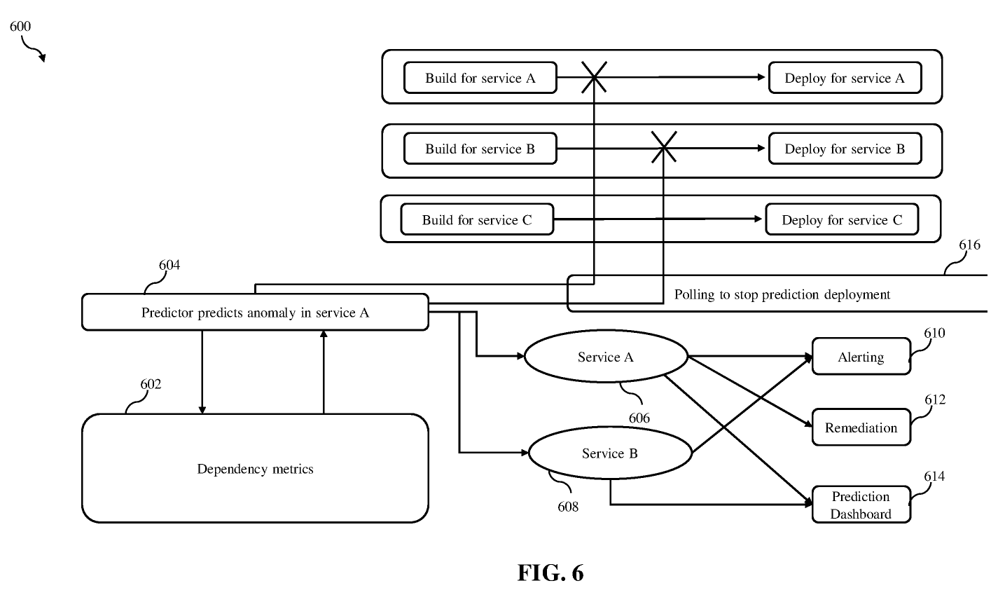

FIG. 6 illustrates an exemplary dependency graph 600 for evaluating and visualizing an impact of the identified set of anomalies on a set of applications within the application environment, in accordance with an exemplary embodiment of the present disclosure.

As shown in FIG. 6, the dependency graph 600 for evaluating and visualizing an impact of the identified set of anomalies on a set of applications within the application environment depicts how prediction polling in one service leads to action on a dependent service. When a predictor 604 identifies an anomaly in Service A 606, it triggers the associated alerting mechanism 610, notifying relevant stakeholders about the issue. The dependency metrics 602 then evaluates the relationship between Service A 606 and other connected services, such as Service B 608. Based on the dependency, the alerting mechanism 610 propagates the alert to Service B 608, as its functionality may be affected by the anomaly in Service A 606.

To address the anomaly, the remediation module 612 gets initiated that focuses on resolving the issue in Service A 606, which is identified as the root cause. This proactive remediation prevents the anomaly from cascading further into dependent services like Service B 608.

The dependency graph 600 further may include a polling mechanism 616. Once the predictor 604 identifies an anomaly, the polling mechanism 616 polls other services impacted by the anomaly to take pre-emptive actions, such as halting deployments or triggering restarts, based on the defined rules and dependencies.

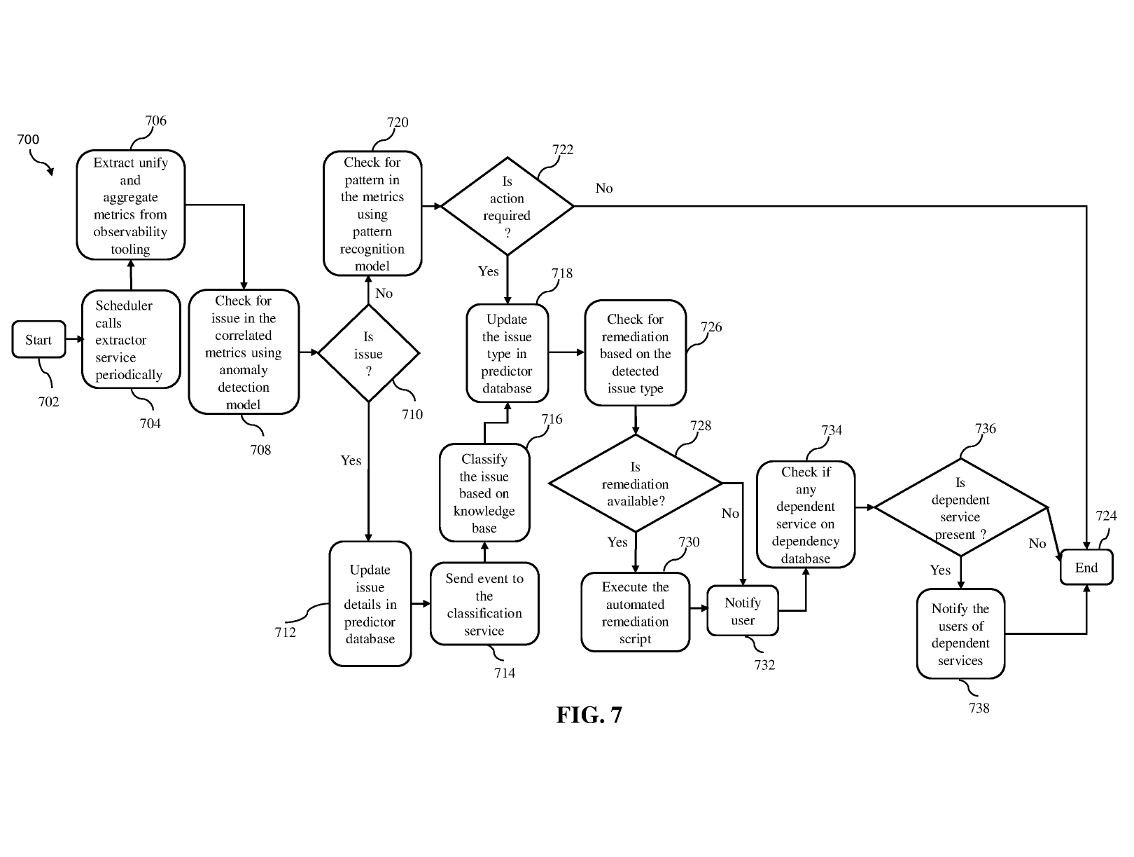

FIG. 7 illustrates an exemplary process 700 flow diagram for predicting incidents in an application environment, in accordance with an exemplary embodiment of the present disclosure. The process 700 starts at step 702.

At step 704, the process 700 includes scheduling calls at extractor service periodically. A scheduler is set up to periodically call the extractor service. This service is responsible for collecting metrics from various observability tools across the application ecosystem at regular intervals. These calls ensure that data is gathered in a timely manner for subsequent analysis.

At step 706, the process 700 includes extracting, unifying and aggregating metrics from observability tooling. The extractor service may gather metrics such as API requests, system health status, logs, CPU usage, and more. It then unifies and aggregates this data into a cohesive format, making it ready for further processing and predictive analysis.

At step 708, the process 700 includes checking for issues in the correlated metrics using an anomaly detection model. Using the anomaly detection model, the system may evaluate the aggregated metrics to identify any unusual patterns or deviations that may indicate potential issues or outages in the application environment.

At step 710, the process 700 includes ascertaining whether the issue is resolvable or not. At this stage, the system may determine whether the detected issue is resolvable. If it can be resolved automatically, the process proceeds to update the issue details and classify the issue. Otherwise, the system may move to perform a deeper analysis using pattern recognition models.

At step 712, if the issue is resolvable, the process 700 includes updating issue details in the predictor database. For resolving issues, details such as metrics, logs, and health data are stored in the predictor database. This ensures proper tracking of incidents and facilitates auditing or future reference.

At step 714, the process 700 includes sending an event to the classification service 510 as described with respect to FIG. 5. Once issue details are logged, an event may be sent to the classification service 510. This service plays a critical role in analyzing and categorizing the issue based on predefined knowledge bases and incident types.

At step 716, the process 700 includes classifying the issue based on a knowledge base. The classification service 510 as described with respect to FIG. 5, may examine the issue in detail and categorizes it into one of several predefined types, such as performance issues, functional defects, or infrastructure-related problems. This classification helps determine the next steps for resolution.

At step 718, the process 700 includes updating the issue type in the predictor database.

At step 720, if the issue is not resolved, the process 700 may include checking for a pattern in the metrics using a pattern recognition model. If the issue cannot be resolved through anomaly detection alone, the system may use a pattern recognition model to identify recurring or significant trends in the metrics. This step allows the system to analyze deeper correlations that may not be immediately apparent.

At step 722, the process 700 includes ascertaining whether any action is required or not. In an exemplary embodiment, if an action is required then the process 700 may include updating the issue type in the predictor database as explained in step 718. Based on the detected pattern, the system assesses whether any action is required. If action is necessary, the issue type is updated in the predictor database for further handling.

At step 724, if no action is required then the process 700 terminates.

At step 726, the process 700 may include checking for remediation based on the detected issue type. For resolvable issues, the system verifies whether a remediation script or predefined solution exists for the specific type of issue detected. This ensures efficient resolution when automated solutions are available.

At step 728, the process 700 includes ascertaining whether remediation is available or not. If remediation is available, the system may execute the corresponding script to resolve the issue. If no remediation script is available, the system may notify relevant users about the absence of automated resolution options.

At step 730, if the remediation is available, the process 700 includes executing the automated remediation script. When a remediation script is available, it is executed to address the issue. Afterward, the system may notify users about the successful resolution and the actions taken by the system.

At step 732, the process 700 includes notifying users that the remediation script has been executed. In an exemplary embodiment, if the remediation is not available, the process 700 may further include notifying users of the unavailability of remediation.

At step 734, the process 700 includes checking if any dependent service is available in a dependency database. The system then examines the dependency database to determine if there are any interconnected services that may also be affected by the issue. This ensures that the full impact of the problem is assessed.

At step 736, the process 700 includes ascertaining whether any dependent service is present or not. If dependent services are identified, users of those services may be notified about the situation. If no dependent services are impacted, the process may conclude without further action.

At step 738, if the dependent service is present, the process 700 includes notifying the users of availability of the dependent services. In an exemplary embodiment, upon notifying the users of availability of the dependent services, the process 700 terminates as shown in step 724. For incidents affecting dependent services, the system may send notifications to inform users of the affected services. This ensures that stakeholders are aware of potential impacts and may take necessary precautions.

In an exemplary embodiment, if the dependent service is not present, the process 700 may terminate as shown in step 724. The process may terminate once all necessary actions have been performed. Whether it involves remediation, notifications, or determining that no further action is required, the framework ensures that incidents are handled comprehensively and efficiently.

The present disclosure provides several advantages, as outlined below. The present disclosure introduces a simulation framework for testing high-computing applications, enabling comprehensive testing without deploying these applications in live environments. This framework significantly reduces the development costs associated with high-computing applications by allowing developers to simulate the application performance, resource demands, and potential bottlenecks prior to actual deployment. Additionally, the present disclosure empowers users to detect and monitor a variety of real-time metrics relevant to high-computing applications, such as execution time, cost estimation, and identification of long-running tasks. By providing these insights, users can make data-driven decisions about resource allocation and application optimization. Another key advantage of the present disclosure is its ability to generate recommendations for optimizing high-computing applications without actually executing them on physical infrastructure or a live environment. This simulated approach facilitates efficient resource utilization by identifying potential improvements and optimizations during the testing phase, resulting in substantial cost savings on infrastructure and resources. Therefore, the present discourse leads to more efficient development cycles, reduced infrastructure costs, and enhanced application performance.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for predicting incidents in an application environment, the computing device is disclosed. The instructions include executable code which, when executed by a processor, may cause the processor to receive a set of data from a plurality of data sources associated with the application environment. The instructions include executable code which, when executed by a processor, may cause the processor to unify the received set of data into a unified set of metrics. The instructions include executable code which, when executed by a processor, may cause the processor to analyze, using a trained model, the unified set of metrics to identify a set of anomalies indicative of a potential incident. The instructions include executable code which, when executed by a processor, may cause the processor to validate the identified set of anomalies to confirm the potential incident. The instructions include executable code which, when executed by a processor, may cause the processor to generate an alert based on the confirmed potential incident.

Although the present specification describes components and functions that may be implemented in particular embodiments with reference to particular standards and protocols, the present disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to enable a general understanding of the various embodiments. The illustrations are not intended to serve as a complete description of all of the elements and features of apparatus and systems that utilize the structures or methods described herein. Many other embodiments may be apparent to those skilled in the art upon reviewing the present disclosure. Other embodiments may be utilized and derived from the present disclosure, such that structural and logical substitutions and changes may be made without departing from the scope of the present disclosure. Additionally, the illustrations are merely representational and may not be drawn to scale. Certain proportions within the illustrations may be exaggerated, while other proportions may be minimized. Accordingly, the present disclosure and the figures are to be regarded as illustrative rather than restrictive.

One or more embodiments of the present disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those skilled in the art upon reviewing the description.

The Abstract of the present disclosure is submitted with the understanding that it will not be used to interpret or limit the scope or meaning of the claims. In addition, in the foregoing detailed description, various features may be grouped together or described in a single embodiment for the purpose of streamlining the present disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for predicting incidents in an application environment, the method being implemented by at least one processor, the method comprising:
receiving, by the at least one processor, a set of data from a plurality of data sources associated with the application environment;unifying, by the at least one processor, the received set of data into a unified set of metrics;analyzing, by the at least one processor using a trained model, the unified set of metrics to identify a set of anomalies indicative of a potential incident;validating, by the at least one processor, the identified set of anomalies to confirm the potential incident; and generating, by the at least one processor, an alert based on the confirmed potential incident.

2. The method as claimed in claim 1, wherein the method further comprises: triggering, by the at least one processor, a remediation action to rectify the confirmed potential incident.

3. The method as claimed in claim 1, wherein the trained model comprises at least one from among an anomaly detection model, an isolation forest algorithm-based model, and a pattern recognition model.

4. The method as claimed in claim 1, wherein the set of data comprises at least one from among a set of application and server logs, an application programming interface (API) metric, a system metric, a health metric, and a log metric.

5. The method as claimed in claim 1, wherein the set of data is received over a predefined time window.

6. The method as claimed in claim 1, wherein the method further comprises: classifying, by the at least one processor, the confirmed potential incident based on comparison with a knowledge base comprising a set of predefined potential incidents.

7. The method as claimed in claim 1, wherein the method further comprises: rendering, by the at least one processor on a display unit, at least one from among a visualization dashboard, and a predictor dashboard.

8. The method as claimed in claim 1, wherein the model is trained using historical data comprising at least one from among application usage, a set of error logs, and system performance metrics.

9. The method as claimed in claim 1, wherein the method further comprises: analyzing, by the at least one processor, a dependency graph to evaluate and visualize an impact of the identified set of anomalies on a set of applications within the application environment, wherein the dependency graph corresponds to an interconnection of the set of applications.

10. A computing device configured for predicting incidents in an application environment, the computing device comprising:
a processor;
a memory storing instructions; and
a communication interface coupled to each of the processor and the memory, wherein the processor is programmed to cooperate with the instructions to perform operations comprising:
receiving a set of data from a plurality of data sources associated with the application environment;unifying the received set of data into a unified set of metrics;analyzing, using a trained model, the unified set of metrics to identify a set of anomalies indicative of a potential incident;validating the identified set of anomalies to confirm the potential incident; and generating an alert based on the confirmed potential incident.

11. The computing device as claimed in claim 10, wherein the at least one processor is further configured to trigger a remediation action to rectify the confirmed potential incident.

12. The computing device as claimed in claim 10, wherein the trained model comprises at least one from among an anomaly detection model, an isolation forest algorithm-based model, and a pattern recognition model.

13. The computing device as claimed in claim 10, wherein the set of data comprises at least one from among a set of application and server logs, an application programming interface (API) metric, a system metric, a health metric, and a log metric.

14. The computing device as claimed in claim 10, wherein the set of data is received over a predefined time window.

15. The computing device as claimed in claim 10, wherein the operations further comprise:
classify the confirmed potential incident based on comparison with a knowledge base comprising a set of predefined potential incidents.

16. The computing device as claimed in claim 10, wherein the operations further comprise:
render, on a display unit, at least one from among a visualization dashboard, and a predictor dashboard.

17. The computing device as claimed in claim 10, wherein the model is trained using historical data comprising at least one from among application usage, a set of error logs, and system performance metrics.

18. The computing device as claimed in claim 10, wherein the operations further comprise:
analyze a dependency graph to evaluate and visualize an impact of the identified set of anomalies on a set of applications within the application environment, wherein the dependency graph corresponds to an interconnection of the set of applications.

19. A non-transitory computer readable storage medium storing instruction for predicting incidents in an application environment, the instructions comprising executable code which when executed by a processor, causes the processor to perform operations comprising:
receive a set of data from a plurality of data sources associated with the application environment;unify the received set of data into a unified set of metrics;analyze, using a trained model, the unified set of metrics to identify a set of anomalies indicative of a potential incident;validate the identified set of anomalies to confirm the potential incident; and generate an alert based on the confirmed potential incident.

20. The storage medium as claimed in claim 19, wherein the processor further performs operations comprising:
triggering a remediation action to rectify the confirmed potential incident.
